(19) United States
(12) Patent Application Publication
(10) Pub. No.: US 2013/0025983 A1
(43) Pub. Date: Jan. 31, 2013

(54) Disc Brake Having Reduced Residual Grinding Torque

(71) Applicant: Ernst Wolf, Koblenz (DE)

(72) Inventor: Ernst Wolf, Koblenz (DE)

(73) Assignee: LUCAS AUTOMOTIVE GMBH, Koblenz (DE)

(21) Appl. No.: 13/575,142

(22) PCT Filed: Jan. 25, 2011
(86) PCT No.: PCT/EP2011/000310

§ 371 Date: Sep. 13, 2012

(30) Foreign Application Priority Data
Jan. 29, 2010 (DE) 10 2010 006 207.3

(51) Int. Cl. B60T 1/06; F16D 55/22; F16J 15/16

(52) U.S. Cl. 188/72.4; 277/500

(57) ABSTRACT

The invention relates to a disc brake having at least one brake disc, at least one friction lining and at least one actuating apparatus, wherein the actuating apparatus comprises at least one actuating piston which is movably housed in a housing of the disc brake and a sealing element having a first sealing surface configured to produce a sealing contact to a contact surface of the housing, and a second sealing surface configured to produce a sealing contact to a contact surface of the actuating piston in order to seal the actuating piston to the housing, wherein at least one of the sealing surfaces comprises a friction surface configured so that it maintains the sealing contact to the contact surface in the case of a movement of the actuating piston relative to the housing and furthermore allows a frictionless movement of the actuating piston relative to the housing.

### CROSS-REFERENCE TO RELATED APPLICATIONS

This application is a national stage of International Application No. PCT/EP2011/000310 filed Jan. 25, 2011, the disclosures of which are incorporated herein by reference in entirety, and which claimed priority to German Patent Application No. DE 10 2010 006 207.3 filed Jan. 29, 2010, the disclosures of which are incorporated herein by reference in entirety.

### BACKGROUND OF THE INVENTION

The invention relates to a disc brake for a motor vehicle, wherein the disc brake comprises at least one brake disc, at least one friction lining and at least one actuating apparatus which is suitable for effecting a relative movement between the brake disc and the friction lining so that this latter comes into friction-braking contact at least in sections with the brake disc. The actuating apparatus comprises at least one actuating piston which is movably housed in a housing of the disc brake and a sealing element having a first sealing surface which is designed to produce a sealing contact with a contact surface of the housing, and a second sealing surface which is designed to produce a sealing contact with a contact surface of the actuating piston in order to seal the actuating piston with respect to the housing.

Disc brake arrangements in various designs are known from the prior art. For example, document DE 10 2006 018 953 A1 discloses a disc brake arrangement having a fixed and a movable friction lining and an actuating apparatus for pressing the movable friction lining against the brake disc. To this end, the actuating apparatus has a brake piston which is axially displaceably housed in a bore of a floating calliper and is sealed in the bore by means of a sealing ring, for example a quad-ring.

If the movable friction brake lining is pressed against the brake disc in an actuating direction by the piston, the sealing ring is thus elastically deformed. When the floating calliper brake is released, the sealing ring assumes its original shape again and thus draws the piston a short distance back into the bore of the floating calliper in the opposite direction to the actuating direction. The movable friction lining is lifted off the brake disc so that a so-called air gap is produced between the brake disc and the movable friction lining. The term “air gap” here refers to a gap between the brake disc and the friction lining. The elastic resetting effect of the sealing element is also known in practice as a so-called “roll-back effect”.

Although the air gap which can be achieved by the prior art has the advantage of enabling the cancellation of residual grinding torques between the brake disc and the friction lining of the disc brake, it is however linked to a disadvantageous increase in the actuating path of the brake since it is necessary to overcome the air gap until the brake comes into effect, i.e. the path which has to be covered by the piston until its movement results in the friction lining coming into contact with the brake disc.

Furthermore, if there is already a significant amount of wear on the brake lining, the brake piston has to be repositioned, i.e. it has to be able to correspond to the brake lining wear in order to prevent a further increase in the air gap.

In such a case, the actuating force exceeds the static friction limit of the sealing element on the contact surface with the brake piston, so that the sealing element is consequently repositioned relative to the brake piston. A repositioning of this type into a position which is further removed, i.e. moving towards the brake lining, is necessary within predefined limits and serves to automatically reposition the brake lining with respect to the brake disc and therefore also to reduce relatively large actuating paths.

However, it may be that such a repositioning already occurs when the brake linings are still without any corresponding wear, which is attributed in particular to the band width at possible static friction states of the sealing element with respect to the actuating piston. In such a case, the otherwise advantageous elastic resetting effect can be reversed and result in the brake lining no longer being drawn away from the brake disc after braking, as originally intended. Instead, the sealing element which is repositioned relative to the friction lining may even counteract a resetting movement so that the friction lining remains on the brake disc or is even pressed against the brake disc by the sealing element, which can lead to significant residual grinding torques which are still in effect after the braking procedure has ended.

Such a reversal of the desired effect of the sealing element can occur in particular when not only a hydraulic brake-force generating device, but also a mechanical force generating device, for example that of an electromechanically driven parking brake, can act together or separately on the disc brake. In the particularly disadvantageous case of the actuating piston being acted upon purely mechanically, the hydraulic application of pressure is namely omitted, which means that the sealing element is not in contact with the actuating piston under hydraulic pre-tension in addition to the pre-tension on assembly, as is otherwise the case. As a result, the static friction between the sealing element and the actuating piston is lower than usual in the absence of the additional hydraulic pre-tension. Consequently, the actuating piston is more readily able to “slip” in undesired manner with respect to the sealing element.

Although the above-mentioned disadvantages can be prevented by complex structural measures or through the choice of a particular material for the sealing element, these measures are particularly expensive.

### BRIEF SUMMARY OF THE INVENTION

Therefore, a feature of the present invention is to provide a disc brake of the type described at the outset, which prevents the occurrence of high residual grinding torques and provides a slight air gap before the noticeable actuation of the brake, whilst thereby enabling the expensive measures mentioned above to be omitted.

This feature is achieved by a disc brake of the type described at the outset, in which at least one of the sealing surfaces comprises a sliding surface which is designed so that it maintains the sealing contact with the contact surface upon a movement of the actuating piston relative to the housing and furthermore allows a low-friction movement of the piston relative to the housing.

When the sealing element is designed in this way, it provides a low degree of resistance to the displacement of the associated actuating piston so that the elastic resetting effect of the sealing element as known from the prior art (roll-back effect) cannot arise. The above-mentioned disadvantageous effects of an undesired repositioning and the resultant residual grinding torques are thus effectively prevented. At the same time, the low-friction sealing with the aid of the sealing element according to the invention enables the actuating piston to be reset simply in its starting position.

The sealing element can furthermore be made of a rubber elastic material. This enables a particularly good sealing effect of the sealing element to be achieved, particularly in the case of a hydraulic actuating device. The sealing element can furthermore be constructed in a groove-like recess of the housing or the actuating piston. In one embodiment, the groove-like recess is formed at least partially on the inner circumferential surface of the housing. Alternatively, however, the groove-like recess can also be at least partially formed on the outer circumferential surface of the actuating piston. Here, the groove-like recess can be constructed in one piece with the housing or the actuating piston, or it can be formed by a plurality of elements forming a groove of this type.

The sealing element is particularly advantageously made from a low-friction material, for example from a rubber elastic material, which has a relatively low friction coefficient, for example EPDM (ethylene propylene diene rubber). EPDM elastomers moreover have the advantage of having a high chemical resistance.

Alternatively or additionally, the sealing element can have a friction-reducing coating, at least in the region of the sliding surface, which enables the static friction between the sealing element and the respective contact surface to be significantly reduced.

The sealing element can moreover have at least one contact section projecting in the direction of the respective contact surface, at least in the region of the sliding surface. A plurality of contact sections forming a profiled contact surface are also conceivable here. Therefore, it is thus already possible to reduce the friction between the sliding surface and the respective contact surface in that the effective friction surface is reduced to the projecting contact sections.

In a special embodiment, the sealing element can have a substantially rectangular cross-section which is characterised by four mutually spaced bead-like contact sections integrally formed on the corners.

It can furthermore be provided for the contact surface contacted by the sliding surface of the sealing element to be made from a low-friction material or coated with such. This measure can also significantly reduce the effective friction force.

It can furthermore be provided that, in relation to a longitudinal axis of the actuating piston, the sealing groove has a radial height and an axial width whereof the ratio to one another is in a range of 0.68 to 0.75. The radial height here is defined as the radial extent of the sealing groove in relation to the longitudinal axis of the actuating piston, whilst the axial width is the extent of the sealing groove along the longitudinal axis of the actuating piston. A ratio of 0.71 has proven to be a particularly preferred ratio in practice.

It can furthermore be provided for the sealing element to have an enveloping surface, i.e. an envelope form which corresponds to the shape of the sealing groove and in which the sealing element is inscribed, the enclosed volume thereof being twelve to eighteen percent greater in a dismantled state of the sealing element than the free volume which is formed by the groove and provided for housing the sealing element. When the sealing element is housed in the groove in an installed state, its envelope is reduced owing to the elastic deformation of the sealing element to enable the sealing element to be housed in the groove.

The invention furthermore relates to a sealing element for use in a disc brake according to the features mentioned above.

Other advantages of this invention will become apparent to those skilled in the art from the following detailed description of the preferred embodiments, when read in light of the accompanying drawings.

### BRIEF DESCRIPTION OF THE DRAWINGS

FIG. 1 is a first embodiment of a disc brake according to the invention in a partially cut-away side view;

FIG. 2 is a second embodiment of a disc brake according to the invention in a view according to FIG. 1; and

FIG. 3 is a detailed view of the section A in FIG. 1.

### DETAILED DESCRIPTION OF THE INVENTION

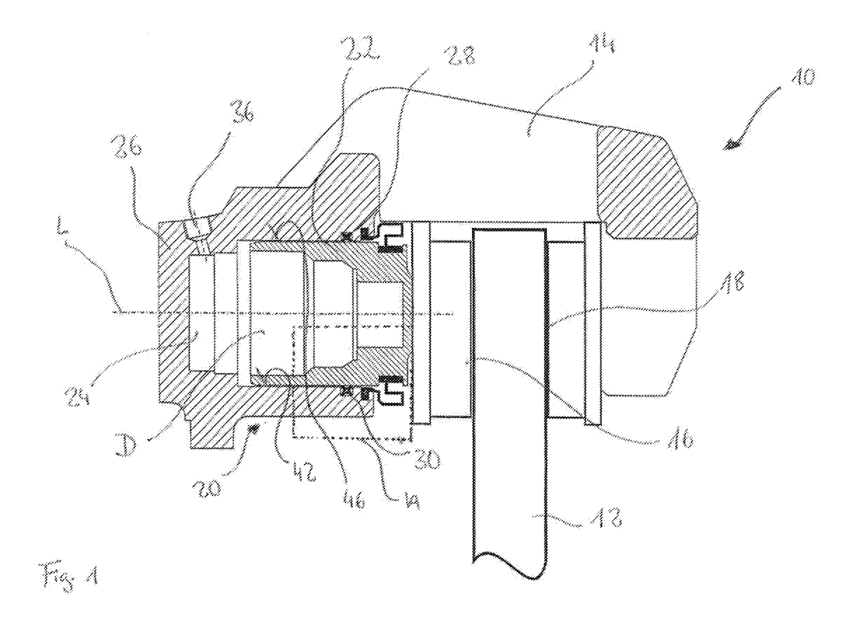

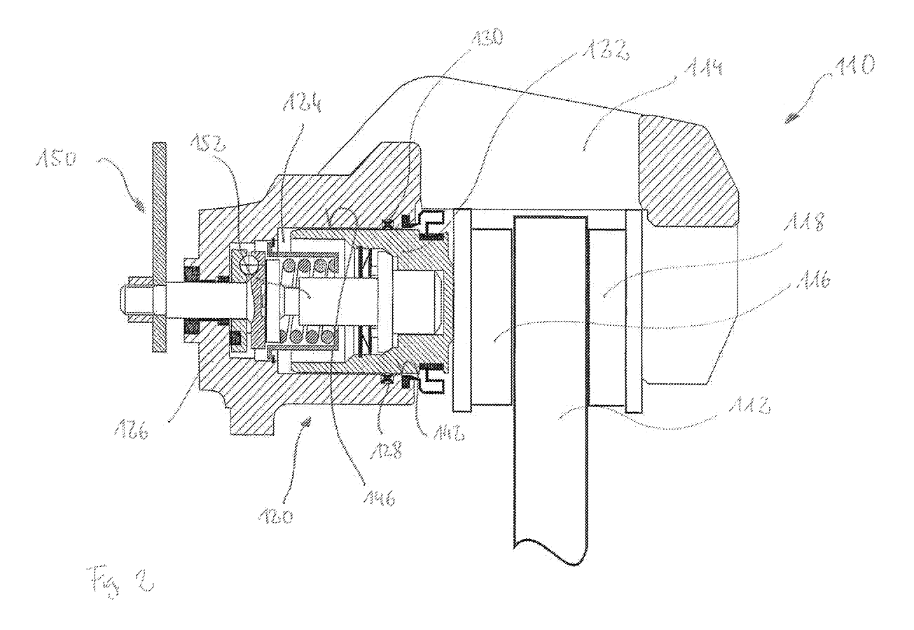

FIG. 1 shows a disc brake 10 according to the invention for a motor vehicle according to a first embodiment, in which the disc brake is hydraulically actuated. FIG. 2 shows a further embodiment which is provided with the same reference numerals where it has the same elements, but with the digit “1” added in front.

The disc brake 10 comprises a brake disc 12, a brake calliper 14 which is coupled to a wheel suspension of the vehicle (not shown) and reaches around the brake disc 12, and friction linings 16, 18 which are housed opposite one another in the brake calliper 14. The friction linings 16, 18 face the friction surfaces of the brake disc 12 and generate a desired brake force on contact with the brake disc 12.

The disc brake 10 furthermore has an actuating apparatus 20 which serves to bring the friction linings 16, 18 into contact with the brake disc 12. To this end, the actuating apparatus 20 has an actuating piston 22 which is housed in a bore 24 within a housing 26, the longitudinal axis L of the actuating piston 22 coinciding with a bore axis of the housing bore 24. In the embodiment shown in FIG. 1, the actuating piston 22 is actuated hydraulically, the actuating piston 22 forming a hydraulic pressure chamber D together with the housing 26.

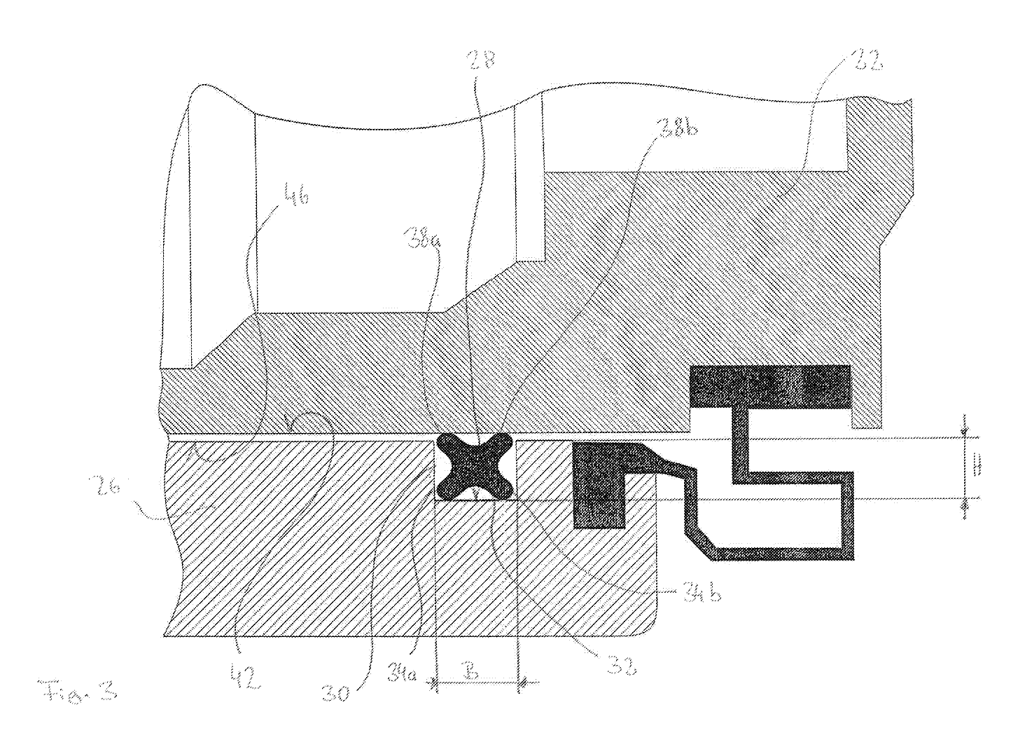

A sealing element 28 is furthermore provided for sealing the actuating piston 22 with respect to the housing 26. As shown in FIG. 1 and illustrated in more detail in FIG. 3, the sealing element 28 is housed in a groove 30 which is formed in the housing 26. The sealing element 28 has a first sealing surface which produces a sealing contact with the inner circumferential surface 46 of the housing 26, the groove base 32 of the groove 30 in the embodiment shown. The sealing element 28 furthermore has a second sealing surface which produces a sealing contact with the outer circumferential surface 42 of the actuating piston 22.

In that embodiment of the sealing element 28 which is shown in FIGS. 1 to 3, the sealing surface is provided by four mutually spaced bead-like contact sections 34a, 34b and 38a, 38b of the sealing element 28 which are integrally formed on the respective corners of the sealing element 28. Here, the two contact sections 34a, 34b which are in contact with the inner circumferential surface 46 of the housing 26 form the first sealing surface and the two contact sections 38a, 38b which are in contact with the outer circumferential surface 42 of the actuating piston 22 form the second sealing surface. The second sealing surface here works as a sliding surface which allows the actuating piston 22 to slide relative to the sealing element 28 and the housing 26 with as little friction as possible.

In relation to the longitudinal axis L of the actuating piston 22, the sealing groove 30 has a radial height H and an axial width B whereof the ratio to one another is in a range of 0.68 to 0.75. A preferred ratio of 0.71 has proven particularly advantageous in practice.

Furthermore, in relation to the sealing groove 30, the associated sealing element 28 has an excess of twelve to eighteen percent, i.e. the volume of the envelope of the sealing element 28 in a dismantled state of the sealing element 28 is twelve to eighteen percent greater than the free volume of the sealing groove 30. In an installed state of the sealing element 28, as shown in FIG. 3, this is elastically deformed accordingly so that it can be housed in the sealing groove 30.

Upon actuation of the disc brake 10, fluid is supplied to the pressure chamber D by way of an inlet, producing an overpressure in the chamber D which causes it to expand. Upon such expansion, the actuating piston 22 is moved relative to its starting position along its longitudinal axis L in the direction of the brake disc 12, i.e. to the right in FIG. 1, whilst the housing 26 together with the full floating brake calliper 14 is displaced to the left in relation to its starting position, causing the brake linings 16 and 18 to come into contact with the brake disc 12. Here, the actuating piston 22 slides relative to the housing 26 with substantially little resistance so that it is slightly outside the bore 24 of the housing 26.

After completion of a brake application, the fluid is discharged back out of the pressure chamber D by way of the inlet 36. Owing to the low friction forces, the actuating piston 22 is in this case able to slide back into its starting position in the bore 24 of the housing 26 without any notable resistance.

The release procedure of the disc brake 10 is additionally promoted in that, on application of pressure, the disc brake 10 has elastic properties which include both the elastic properties of the brake calliper 14 and of the friction linings 16, 18, these being reset upon release of the brake 10 together with the friction linings 16, 18.

This enables the actuating piston 22 and the brake calliper 14 to be reset with respect to one another as simply and effectively as possible, thereby enabling the prevention of residual grinding torques on the brake disc 12.

In the second embodiment shown in FIG. 2, the disc brake 110 can be actuated purely hydraulically, purely mechanically or hydraulically and mechanically combined, as known for example with respect to so-called parking brakes. The actuating apparatus 120 in this embodiment also comprises an actuating piston 122 which is housed in a bore 124 of a housing 126.

Mechanical actuation causes the actuating piston 122 to be displaced in known manner relative to the brake calliper 114 by means of an activating element 150, i.e. the brake piston 122 is displaced to the right in the drawing shown in FIG. 2, whilst the brake calliper 114 is displaced to the left so that the friction linings 116, 118 come into contact with the brake disc 112. Thus, by way of the activating element 150, a transfer piston 152 transfers the mechanical actuating force to both the actuating piston 122 and the housing 126 so that these are displaced relative to one another. A conventional wear readjustment arrangement 154 is furthermore provided, which is not explained in more detail below.

In this embodiment, the design of the sealing element 128 also contributes in the manner described in FIGS. 1 and 3 to enabling a virtually resistance-free relative movement of the actuating piston 122 relative to the housing 126, as a result of which residual grinding torques on the brake disc 112 after the disc brake 110 has been released can be effectively diminished or at least notably reduced and, at the same time, a slight air gap is provided.

In accordance with the provisions of the patent statutes, the principle and mode of operation of this invention have been explained and illustrated in its preferred embodiments. However, it must be understood that this invention may be practiced otherwise than as specifically explained and illustrated without departing from its spirit or scope.

1. A disc brake (10; 110) for a motor vehicle,
wherein the disc brake (10, 110) comprises at least one brake disc (12; 112), at least one friction lining (14, 16; 114, 116) and at least one actuating apparatus (20; 120) which is suitable for effecting a relative movement between the brake disc (12; 112) and the friction lining (14, 16; 114, 116) so that this latter comes into friction-braking contact at least in sections with the brake disc (12; 112), wherein the actuating apparatus (20; 120) comprises at least one actuating piston (22; 122) which is movably housed in a housing (26; 126) of the disc brake (10; 110) and
a sealing element (28; 128) having a first sealing surface which is designed to produce a sealing contact with a contact surface of the housing (26; 126) and a second sealing surface which is designed to produce a sealing contact with a contact surface of the actuating piston (22; 122) in order to seal the actuating piston (22; 122) with respect to the housing (26; 126),
characterised in that at least one of the sealing surfaces comprises a sliding surface which is designed so that it maintains the sealing contact with the contact surface upon a movement of the actuating piston (22; 122) relative to the housing (26; 126) and furthermore allows a low-friction movement of the actuating piston (22; 122) relative to the housing (26; 126).

2. A disc brake (10; 110) according to claim 1,
characterised in that the sealing element (28; 128) is made of a rubber elastic material.

3. A disc brake (10; 110) according to claim 1 or 2,
characterised in that the sealing element (28; 128) is housed in a groove-like recess (30; 130) of the housing (26; 126) or the actuating piston (22; 122).

4. A disc brake (10; 110) according to claim 3,
characterised in that the groove-like recess (30; 13) is formed at least partially on the inner circumferential surface (46; 146) of the housing (26; 126).

5. A disc brake (10; 110) according to claim 3,
characterised in that the groove-like recess (30, 130) is formed at least partially on the outer circumferential surface (42; 142) of the actuating piston (22; 122).

6. A disc brake (10; 110) according to one of the preceding claims,
characterised in that the sealing element (28; 128) is made from a low-friction material, for example a low-friction rubber elastic material.

7. A disc brake (10; 110) according to one of the preceding claims,
characterised in that the sealing element (28; 128) has a friction-reducing coating at least in the region of the sliding surface.

8. A disc brake (10; 110) according to one of the preceding claims,
characterised in that the sealing element (28; 128) has at least one contact section (38a,b; 138a,b) projecting in the direction of the respective contact surface, at least in the region of the sliding surface.

9. A disc brake (10; 110) according to one of the preceding claims,
characterised in that the contact surface which is contacted by the sliding surface is made from a low-friction material or is coated with such.

10. A disc brake (10; 110) according to one of the preceding claims,
characterised in that, in relation to a longitudinal axis (L) of the actuating piston (22), the sealing groove (30; 130) has a radial height and an axial width whereof the ratio to one another is in a range of 0.68 to 0.75.

11. A disc brake (10; 110) according to one of the preceding claims,
characterised in that the sealing element (28; 128) has an enveloping surface, wherein the volume enclosed thereby is twelve to eighteen percent greater than the volume of the groove (30; 130) housing the sealing element (28; 128).

12. A sealing element (28; 128) for use in a disc brake (10; 110) having the features of claims 1 to 11.
